(19) United States
(12) Patent Application Publication
(10) Pub. No.: US 2017/0304888 A1
(43) Pub. Date: Oct. 26, 2017

(54) CASTING CORE AND METHOD FOR TESTING A HOLLOW METAL ARTICLE

(71) Applicant: United Technologies Corporation, Farmington, CT (US)

(72) Inventors: Lea Kennard Castle, Vernon, CT (US); Mario P. Bochiechio, Vernon, CT (US); Shiela R. Woodard, South Windsor, CT (US); James Tilsley Auxier, Bloomfield, CT (US)

(21) Appl. No.: 15/137,183

(22) Filed: Apr. 25, 2016

(51) Int. Cl. B22C 3/00; G01N 23/00; B22D 29/00

(52) U.S. Cl. CPC B22C 3/00; B22D 29/002; G01N 23/00

(57) ABSTRACT

A hollow metal article can be fabricated by casting a molten metal alloy around a core, solidifying the molten metal alloy to form a metal article, and chemically removing the core from the metal article to form a hollow cavity in the metal article. The core includes a ceramic core body and an x-ray radiopaque coating disposed on the ceramic core body. A method for testing the hollow metal article includes submitting the hollow metal article to x-ray imaging and determining based upon the x-ray imaging whether any of the x-ray radiopaque coating of the core remains in the hollow metal article.

### BACKGROUND

Investment casting is known and used to fabricate metal articles. For example, gas turbine engine components, such as airfoils, are fabricated by investment casting. For articles that are hollow, an internal cavity can be formed using a core that represents a positive projection of negative features that are to be formed in the casting process. A wax pattern is provided around the core in the geometry of the component to be cast. A refractory shell is formed around the wax pattern and the wax is then removed to form a mold cavity between the core and the shell. Molten metal is poured into the mold cavity. After solidification of the metal, the shell is mechanically removed and the core is chemically removed by leaching.

### SUMMARY

A hollow metal article is fabricated by casting a molten metal alloy around a core that had a ceramic core body and an x-ray radiopaque coating disposed on the ceramic core body. The core is chemically removed. A method for testing the hollow metal article according to an example of the present disclosure includes submitting a hollow metal article to x-ray imaging and determining based upon the x-ray imaging whether any of the x-ray radiopaque coating of the core remains in the hollow metal article.

In a further embodiment of any of the foregoing embodiments, the x-ray radiopaque coating has a greater x-ray attenuation than the hollow metal article.

In a further embodiment of any of the foregoing embodiments, the x-ray radiopaque coating includes at least one refractory metal chemical element.

In a further embodiment of any of the foregoing embodiments, at least one refractory metal chemical element is selected from a group consisting of niobium, molybdenum, tantalum, tungsten, rhenium, and combinations thereof.

In a further embodiment of any of the foregoing embodiments, at least one refractory metal chemical element is selected from a group consisting of titanium, vanadium, chromium, zirconium, hafnium, ruthenium, rhodium, osmium, iridium, and combinations thereof.

A further embodiment of any of the foregoing embodiments includes submitting the hollow metal article to an additional removal process if any of the x-ray radiopaque coating of the core remains in the hollow metal article.

A method for testing a hollow metal article according to an example of the present disclosure includes casting a molten metal alloy around a core and solidifying the molten metal alloy to form a metal article. The core includes a ceramic core body and an x-ray radiopaque coating disposed on the ceramic core body. The core is chemically removed from the metal article to form a hollow cavity in the metal article. After chemically removing the core, the article is submitted to x-ray imaging to determine based upon the x-ray imaging whether any of the x-ray radiopaque coating of the core remains in the hollow cavity.

In a further embodiment of any of the foregoing embodiments, x-ray radiopaque coating encloses the ceramic core body.

In a further embodiment of any of the foregoing embodiments, the x-ray radiopaque coating includes at least one refractory metal chemical element.

In a further embodiment of any of the foregoing embodiments, the at least one refractory metal chemical element is in metallic form.

In a further embodiment of any of the foregoing embodiments, the at least one refractory metal chemical element is in oxide form.

In a further embodiment of any of the foregoing embodiments, the x-ray radiopaque coating consists of at least one refractory metal chemical element in metallic form, oxide form, or combinations thereof.

A further embodiment of any of the foregoing embodiments includes fabricating the core by depositing the x-ray radiopaque coating on the ceramic core body.

In a further embodiment of any of the foregoing embodiments, x-ray radiopaque coating has a thickness of 13 micrometers or less.

In a further embodiment of any of the foregoing embodiments, the ceramic core body has a maximum thickness and the x-ray radiopaque coating has a thickness of 5% or less of the maximum thickness of the ceramic core body.

A casting core according to an example of the present disclosure includes a ceramic core body configured for forming a cavity in a metal article, and an x-ray radiopaque coating disposed on the ceramic core body.

In a further embodiment of any of the foregoing embodiments, the x-ray radiopaque coating encloses the ceramic core body.

In a further embodiment of any of the foregoing embodiments, the x-ray radiopaque coating includes at least one refractory metal chemical element.

In a further embodiment of any of the foregoing embodiments, the x-ray radiopaque coating includes at least one refractory metal chemical element selected from a group consisting of niobium, molybdenum, tantalum, tungsten, rhenium, titanium, vanadium, chromium, zirconium, hafnium, ruthenium, rhodium, osmium, iridium, and combinations thereof.

In a further embodiment of any of the foregoing embodiments, the ceramic core body has a maximum thickness and the x-ray radiopaque coating has a thickness of 5% or less of the maximum thickness of the ceramic core body.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates an example method for testing a hollow metal article.

FIG. 2 illustrates an example of a casting core that can be used in connection with the method of FIG. 1.

FIG. 3 illustrates a sectioned view of the core of FIG. 2.

### DETAILED DESCRIPTION

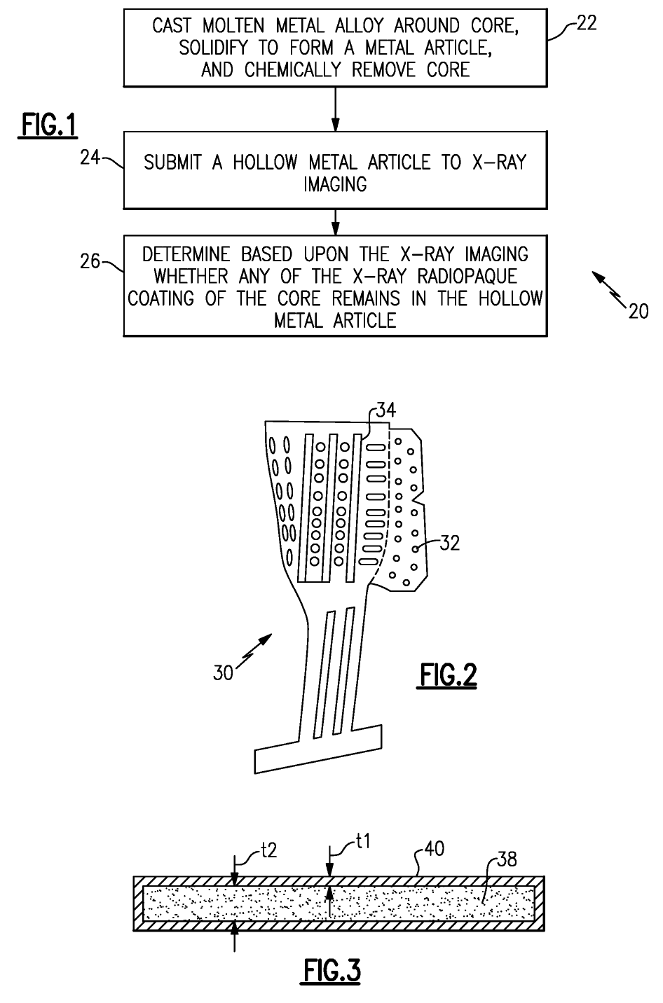

FIG. 1 schematically illustrates an example method 20 for testing a hollow metal article. As will be appreciated, the hollow metal article may be, but is not limited to, gas turbine engine components such as airfoils that are cast of a superalloy material (e.g., a nickel- or cobalt-based alloy). The method 20 may be used as a replacement to neutron radiography testing in connection with fabrication of the hollow metal article, or used as a separate, stand-alone testing technique after fabrication of the hollow metal article.

As an example, at 22 the fabrication of the hollow metal article may include casting a molten metal alloy around a core and solidifying the molten metal alloy to form a metal article. After solidification, the core is chemically removed from the metal article, such as by chemical leaching with a strong pH base solution, to form a hollow cavity in the article.

The leaching process may not fully remove the core. For instance, hollow cavities that have small passages, serpentine passages, and/or “dead-end” passages have the potential to impede core removal and result in a residual amount of the core remaining in the article. In this regard, the method 20 provides a technique for non-destructively determining by x-ray imagery whether any residual amount of the core remains in the article after leaching.

FIG. 2 shows an example of a core 30 that may be used in connection with the method 20. As will be appreciated, the geometry of the core 30 is not limited. For example only and to illustrate several potential features of the core 30, the core 30 is depicted with orifices 32 for forming pedestals or other structures in the article and elongated channels 34 for forming ribs in the article. Additionally, although shown with a relatively flat geometry, the core 30 may be contoured or curved according to the desired geometry of a given article and hollow cavity.

The core 30 is adapted for detection by x-ray imagery in the method 20. For instance, as shown in the sectioned view in FIG. 3, the core 30 includes a ceramic core body 38 and an x-ray radiopaque coating 40 disposed on, and bonded with, the ceramic core body 38. The ceramic core body 38 may be formed of one or more ceramic oxide materials. Such ceramic oxide materials may include, but are not limited to silicates, such as aluminosilicate and zirconium silicate, silica, alumnia, calcia, magnesia, yttria and combinations thereof.

In the illustrated example, the x-ray radiopaque coating 40 is a layer of relatively uniform thickness that encloses the ceramic core body 38. Alternatively, the x-ray radiopaque coating 40 may be disposed on only a portion of the ceramic core body 38, leaving other portions of the ceramic core body 38 without the x-ray radiopaque coating 40. The x-ray radiopaque coating 40 may be deposited on the ceramic core body by air plasma spray, low pressure plasma spray, physical vapor deposition, chemical vapor deposition, dip coating, or brush coating, but is not limited to these deposition techniques.

The x-ray radiopaque coating 40 has greater x-ray attenuation than the metal (e.g., superalloy) from which the article is formed. For instance, the x-ray radiopaque coating 40 includes at least one refractory metal chemical element. The refractory metal chemical element or elements may be niobium, molybdenum, tantalum, tungsten, rhenium, titanium, vanadium, chromium, zirconium, hafnium, ruthenium, rhodium, osmium, iridium, or combinations thereof.

The refractory metal chemical element or elements may be in metallic form, oxide form, or a combination of metallic form and oxide form. In one example, the x-ray radiopaque coating 40 may also include additional materials or constituents that do not function for x-ray detection. In another example, the x-ray radiopaque coating 40 has only the refractory metal chemical element or elements, and possibly impurities.

The x-ray radiopaque coating 40 permits any residual amount of the core 30 in the article to be distinguished in the x-ray imagery of the method 20. For example, at 24 the method 20 includes submitting the hollow metal article to x-ray imaging. The x-ray imaging can be conducted on known equipment using techniques known to those skilled in the art. In a further example, the orientation of the hollow metal article may be manipulated such that the x-ray imaging captures one or more views of any small passages, serpentine passages, and/or “dead-end” passages of the article that may have a greater potential to impede core removal.

The x-ray imaging produces one or more radiographs that contains an image of the article. At 26 the method 20 includes determining based upon the x-ray imaging whether any of the x-ray radiopaque coating 40 of the core 30 remains in the hollow metal article. For example, the x-ray radiopaque coating 40 has greater x-ray attenuation than the metal alloy of the article, and any residual amount of the x-ray radiopaque coating 40 will absorb or scatter x-rays to a greater degree than the metal. When exposed to x-ray imaging, any residual amount of the x-ray radiopaque coating 40 will thus present with greater contrast on the radiograph. The greater contrast is then used to identify the presence, or not, of any residual amount of the core 30 in the article. For example, since the x-ray radiopaque coating 40 is bonded with the ceramic core body 38, the presence of the x-ray radiopaque coating 40 may be indicative of residual ceramic core body 38 in the hollow metal article (i.e., a residual piece of the core 30 that has the x-ray radiopaque coating 40 and the ceramic core body 38). In this regard, the refractory elements that have heavier molecular weights, in comparison to nickel or cobalt of the metal alloy of the article, may provide greater contrast. If any residual amount of the core 30 is detected in the article, the article can be submitted to an additional removal process, such as further chemical leaching, to remove the residual amount of the core 30. The article can then be tested again using the method 20 to determine whether any of the core 30 still remains.

In a further example, the core 30 includes a relatively small amount of the x-ray radiopaque coating 40 in comparison to the ceramic core body 38. For instance, the x-ray radiopaque coating 40 may have a thickness t1 of 13 micrometers or less. In a further example, the ceramic core body 38 has a maximum thickness t2 and the x-ray radiopaque coating 40 has a thickness of 5% or less of the maximum thickness of the ceramic core body 38. Although a greater amount of the x-ray radiopaque coating 40 could be used and detected in the method 20, greater amounts increase the size of the core 30 and potentially exceed the desired or required dimensional limits of the core 30.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A method for testing a hollow metal article, the method comprising:
submitting a hollow metal article to x-ray imaging, wherein the hollow metal article was fabricated by casting a molten metal alloy around a core that had a ceramic core body and an x-ray radiopaque coating disposed on the ceramic core body, the core having been chemically removed; and
determining based upon the x-ray imaging whether any of the x-ray radiopaque coating of the core remains in the hollow metal article.

2. The method as recited in claim 1, wherein the x-ray radiopaque coating has a greater x-ray attenuation than the hollow metal article.

3. The method as recited in claim 1, wherein the x-ray radiopaque coating includes at least one refractory metal chemical element.

4. The method as recited in claim 3, wherein the at least one refractory metal chemical element is selected from a group consisting of niobium, molybdenum, tantalum, tungsten, rhenium, and combinations thereof.

5. The method as recited in claim 3, wherein the at least one refractory metal chemical element is selected from a group consisting of titanium, vanadium, chromium, zirconium, hafnium, ruthenium, rhodium, osmium, iridium, and combinations thereof.

6. The method as recited in claim 1, further comprising submitting the hollow metal article to an additional removal process if any of the x-ray radiopaque coating of the core remains in the hollow metal article.

7. A method for testing a hollow metal article, the method comprising:
casting a molten metal alloy around a core and solidifying the molten metal alloy to form a metal article, wherein the core includes a ceramic core body and an x-ray radiopaque coating disposed on the ceramic core body;
chemically removing the core from the metal article to form a hollow cavity in the metal article; and
after chemically removing the core, submitting the metal article to x-ray imaging and determining based upon the x-ray imaging whether any of the x-ray radiopaque coating of the core remains in the hollow cavity.

8. The method as recited in claim 7, wherein x-ray radiopaque coating encloses the ceramic core body.

9. The method as recited in claim 7, wherein the x-ray radiopaque coating includes at least one refractory metal chemical element.

10. The method as recited in claim 9, wherein the at least one refractory metal chemical element is in metallic form.

11. The method as recited in claim 9, wherein the at least one refractory metal chemical element is in oxide form.

12. The method as recited in claim 9, wherein the x-ray radiopaque coating consists of the at least one refractory metal chemical element in metallic form, oxide form, or combinations thereof.

13. The method as recited in claim 7, further comprising fabricating the core by depositing the x-ray radiopaque coating on the ceramic core body.

14. The method as recited in claim 7, wherein x-ray radiopaque coating has a thickness of 13 micrometers or less.

15. The method as recited in claim 7, wherein the ceramic core body has a maximum thickness and the x-ray radiopaque coating has a thickness of 5% or less of the maximum thickness of the ceramic core body.

16. A casting core comprising:
a ceramic core body configured for forming a cavity in a metal article; and
an x-ray radiopaque coating disposed on the ceramic core body.

17. The casting core as recited in claim 16, wherein the x-ray radiopaque coating encloses the ceramic core body.

18. The casting core as recited in claim 16, wherein the x-ray radiopaque coating includes at least one refractory metal chemical element.

19. The casting core as recited in claim 16, wherein the x-ray radiopaque coating includes at least one refractory metal chemical element selected from a group consisting of niobium, molybdenum, tantalum, tungsten, rhenium, titanium, vanadium, chromium, zirconium, hafnium, ruthenium, rhodium, osmium, iridium, and combinations thereof.

20. The casting core as recited in claim 16, wherein the ceramic core body has a maximum thickness and the x-ray radiopaque coating has a thickness of 5% or less of the maximum thickness of the ceramic core body.
